(19) United States
(12) Patent Application Publication
(10) Pub. No.: US 2002/0172495 A1
(43) Pub. Date: Nov. 21, 2002

(54) Combination system and automatic copy method thereof

(75) Inventor: Hong-gyu Han, Suwon-city (KR)

Correspondence Address: STAAS & HALSEY LLP, 700 11TH STREET, NW, SUITE 500, WASHINGTON, DC, 20001, US

(73) Assignee: Samsung Electronics Co., Ltd., Suwon-city (KR)

(21) Appl. No.: 10/146,898

(22) Filed: May 17, 2002

(30) Foreign Application Priority Data
May 18, 2001 (KR) 2001-27275

(51) Int. Cl. H04N 7/00; H04N 5/225

(52) U.S. Cl. 386/46; 386/121

(57) ABSTRACT

A combo system includes a play unit to play a signal recorded on a first recording medium and a recording unit to record the signal played by the play unit in a second recording medium. A detector in the combo system detects whether a predetermined still image signal exists within the signal played by the play unit. A controller in the combo system controls the play unit and the recording unit to perform a playing operation and a recording operation, respectively, when the detector detects the still image signal.

### CROSS-REFERENCE TO RELATED APPLICATIONS

This application claims the benefit of Korean Application No. 2001-27275, filed May 18, 2001, in the Korean Patent Office, the disclosure of which is incorporated herein by reference.

### BACKGROUND OF THE INVENTION

1. Field of the Invention

The present invention relates to a combination system and an automatic copy method thereof, and more particularly, to a combination system and an automatic copy method thereof, in which a play unit to play a signal recorded on a recording medium and a recording unit to record the signal played by the play unit in another recording medium are provided.

2. Description of the Related Art

A combination system or combo system is defined as two or more different units incorporated into a combined system. As an example of the combo system, there is provided a DVDP/VCR combo system developed to compositely perform a function of a DVDP and a function of a VCR.

FIG. 1 is a block diagram illustrating a conventional DVDP/VCR combo system 10 and peripheral devices connected to the DVDP/VCR combo system. The DVDP/VCR combo system 10 includes a VCR 11 and a DVDP 12. The VCR 11 performs a general VCR function that plays video and audio signals recorded on a magnetic tape and records externally received signals on the magnetic tape. The DVDP 12 performs a general DVDP function that plays video and audio signals recorded on a DVD. In addition to essential functions of the VCR 11 and the DVDP 12, the DVDP/VCR combo system 10 has an advantage in that the DVDP/VCR combo system 10 can perform a composite function that records video and audio signals played by the DVDP 12 on the magnetic tape through the VCR 11.

A TV 23 is connected to the DVDP/VCR combo system 10 as a peripheral device that outputs video and audio signals played by the DVDP 12 or the VCR 11. Also, an audio amplifier 21 is connected to the DVDP/VCR combo system 10 as a peripheral device that outputs audio signals played by the DVDP 12. Furthermore, an external device 25 such as a camcorder can be connected to the DVDP/VCR combo system 10. The DVDP/VCR combo system 10 serves to record/play video and audio signals from the external device 25.

The VCR 11 and the DVDP 12 in the DVDP/VCR combo system 10 are provided as one system in appearance. A user can switch a mode between the VCR 11 and the DVDP 12 through either a separate input unit such as a remote controller 15 or a panel (not shown) provided on a front surface of the DVDP/VCR combo system 10 and can manipulate individual functions of the respective devices 11 and 12 using the separate input unit. As described above, the DVDP/VCR combo system 10 has an advantage in that the system can perform various functions without the peripheral devices.

However, the aforementioned combo system 10 has several problems. Specifically, in a case where video and audio signals played by the DVDP 12 are recorded on the magnetic tape through the VCR 11, a problem arises in that the same video signals may continuously be recorded. The reason for this problem is because the DVDP 12 has a still menu image, unlike the VCR 11 that automatically performs a play mode if the magnetic tape is inserted, and cannot perform a play mode in a data track unless an external selection signal for a predetermined chapter is entered from the menu image. In other words, in a state where the user is absent after selecting a copy mode, the user may have intended to copy data recorded on the DVD onto the magnetic tape using the combo system. In this case, a problem arises in that the menu image of the DVD may only be recorded on the magnetic tape if there is no external selection signal.

Furthermore, if the magnetic tape is played on which the menu image is recorded, the user cannot view a desired video image. In this case, the user may believe that there is something wrong with the recording function of the combo system.

### SUMMARY OF THE INVENTION

Accordingly, it is an object of the present invention to provide a combination system and an automatic copy method thereof, in which a still video signal, such as menu image data existing in DVD data, can be prevented from being continuously recorded.

To achieve the above and other objects, the present invention may be accomplished by providing a combo system having a play unit to play a signal recorded on a first recording medium and a recording unit to record the signal played by the play unit in a second recording medium, including: a detector to detect whether a predetermined still image signal exists within the signal played by the play unit; and a controller to control the play unit and the recording unit to perform a playing operation and a recording operation, respectively, when the still image signal is detected by the detector.

According to the present invention, if the data recorded on the DVD including a still image signal, such as a menu image signal to provide a predetermined selection menu to a user using an OSD function, is copied in the magnetic tape, an unnecessary copying operation can be avoided and a reliability in an operation of the combo system can be improved.

To achieve the above and other objects, the present invention may be accomplished by providing an automatic copy method of a combo system provided with a play unit and a recording unit, including: playing a signal recorded on a first recording medium using the play unit; recording the signal played in a second recording medium using the recording medium; detecting whether a predetermined still image signal exists within the signal played by the play unit; and performing a playing operation of the play unit and a recording operation of the recording unit when the still image signal is detected.

According to the present invention, in addition to the combo system, a protocol between a player such as a DVDP and a recorder such as a VCR is set using a cable to perform communication, so that an automatic copy method between the player and the recorder is provided.

To achieve the above and other objects, the present invention may be accomplished by providing an automatic copy method between a play unit and a recording unit, including: playing a signal recorded on a first recording medium using the play unit; recording the signal played in a second recording medium using the recording medium; detecting whether a predetermined still image signal exists within the signal played by the play unit; and performing a playing operation of the play unit and a recording operation of the recording unit when the still image signal is detected.

To achieve the above and other objects, the present invention may be accomplished by providing a combo system, including: a play unit playing video and/or audio signals recorded on a first recording medium; a recording unit recording the video and/or audio signals on a second recording medium; a controller detecting a still image signal from the video and/or audio signals played by the play unit; and an OSD block adding an OSD function to the video signals and generating video images, wherein the video images generated by the OSD block are added to the video signals from the recording unit.

To achieve the above and other objects, the present invention may be accomplished by providing an automatic copy method in which a user copies data recorded on a first recording medium on a second recording medium, the method including: selecting a copy command signal from a data processing menu; playing data recorded on the first recording medium in response to the copy command signal; recording the data on the second recording medium; detecting a start point of a menu data among the data recorded on the first recording medium; detecting a menu selection signal to select data from the menu data; playing the selected data from the menu data; recording the selected data on the second recording medium; and detecting a play completion signal.

To achieve the above and other objects, the present invention may be accomplished by providing a combo system having a play unit to play a signal recorded on a first recording medium and a recording unit to record the signal played by the play unit in a second recording medium, including: a detector detecting a still image signal from video and/or audio signals; and a controller preventing the still video signal from being continuously recorded.

To achieve the above and other objects, the present invention may be accomplished by providing a combo system having a play unit and a recording unit, including: a detector detecting a still image or a menu image and generating a detection signal indicative thereof; and a controller controlling the play unit to perform a play operation to reproduce data different from the detected still image or menu image in response to the detection signal.

To achieve the above and other objects, the present invention may be accomplished by providing an apparatus in a DVD play unit having a recording medium, including: a detector detecting a still image or a menu image and generating a detection signal indicative thereof; and a controller controlling the DVD play unit to perform a play operation in response to the detection signal.

To achieve the above and other objects, the present invention may be accomplished by providing an apparatus in a DVD play unit having a recording medium, including: a detector detecting a still image or a menu image recorded on the recording medium to generate a detection signal; and a controller controlling the DVD play unit to perform a play operation to reproduce data different from the detected still image or menu image from the recording medium in response to the detection signal.

To achieve the above and other objects, the present invention may be accomplished by providing a method of a combo system having a play unit and a recording unit, including: detecting a still image or a menu image and generating a detection signal indicative thereof; and controlling the play unit to perform a play operation to reproduce data different from the detected still image or menu image in response to the detection signal.

To achieve the above and other objects, the present invention may be accomplished by providing a method of a DVD play unit having a recording medium, including: detecting a still image or a menu image and generating a detection signal indicative thereof; and controlling the DVD play unit to perform a play operation in response to the detection signal.

To achieve the above and other objects, the present invention may be accomplished by providing a method of a DVD play unit having a recording medium, including: detecting a still image or a menu image recorded on the recording medium to generate a detection signal; and controlling the DVD play unit to perform a play operation to reproduce data different from the detected still image or menu image from the recording medium in response to the detection signal.

These together with other objects and advantages, which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a block diagram illustrating a related DVDP/VCR combination system;

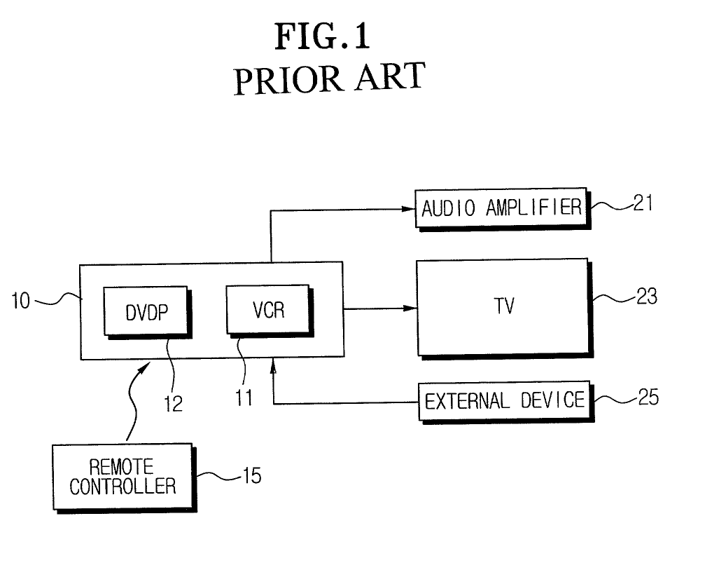

FIG. 2 is a block diagram illustrating a DVDP/VCR combination system, in accordance with the present invention; and

FIG. 3 is a flow chart illustrating an automatic copy method performed by the system shown in FIG. 2.

### DETAILED DESCRIPTION OF THE PREFERRED EMBODIMENTS

A combination system and an automatic copy method thereof in accordance with exemplary embodiments of the present invention will now be described in detail with reference to the accompanying drawings.

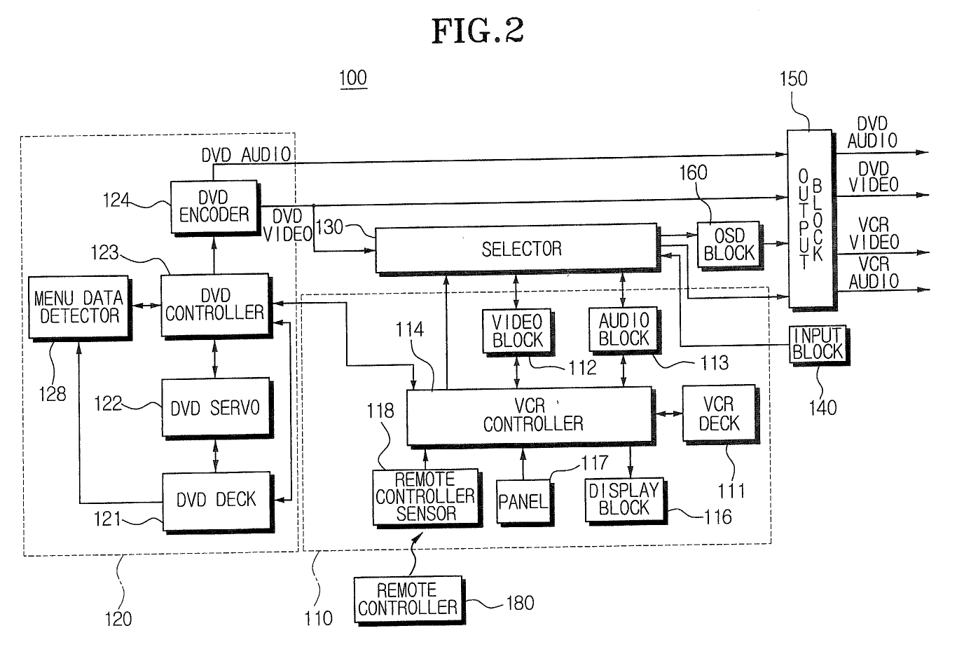

FIG. 2 is a detailed block diagram illustrating a combo system in accordance with a first embodiment of the present invention, particularly a DVDP/VCR combo system 100 that can perform DVDP and VCR functions. The DVDP/VCR combo system 100 includes a VCR 110 to perform a general VCR function, a DVDP 120 to perform a general DVDP function, a selector 130 to select signals output from the VCR 110 and the DVDP 120, and an input block 140 to transmit signals input from an external device, such as a camcorder to the selector 130. An output block 150 transmits the signals output from the VCR 110 and the DVDP 120 to peripheral devices such as a TV and an amplifier. An on screen display (OSD) block 160 in the DVDP/VCR combo system 100 adds an OSD function to video signals output from the VCR 110 and the DVDP 120.

The VCR 110 includes a VCR deck 111 for recording a signal on a magnetic tape or playing the signal recorded on the magnetic tape. Video and audio blocks 112 and 113 in the VCR 110 transmit and receive video and audio signals to be recorded or played to and from the VCR deck 111, and a VCR controller 114 controls an entire operation of the VCR deck 111, the video block 112, and the audio block 113. The VCR 110 further includes a display block 116 to externally display the status of the VCR 110 such as operational, control, and setting modes, a panel 117 to input various commands from a user, and a remote controller sensor 118 to input a command from the user through a remote controller 180.

The DVDP 120 includes a DVD deck 121, a DVD servo 122, a DVD controller 123, and a DVD encoder 124. The DVD deck 121 reads data recorded on a DVD to perform a play mode of the DVD. The DVD servo 122 receives the data read by the DVD deck 121 through the DVD controller 123, and outputs DVD video data and DVD audio data. The DVD controller 123 controls the operation of the DVD deck 121, the DVD servo 122, and the DVD encoder 124. The DVDP 120 further includes a menu data detector 128 for detecting a menu image signal. The menu data detector 128 detects a start point of the menu image signal from the data read from the DVD deck 121, and outputs the detected start point to the DVD controller 123. Then, the DVD controller 123 controls the DVD deck 121 to perform a play mode, and signals the VCR controller 114 of the detection of the menu image signal. The VCR controller 114 controls the VCR deck 111 to perform a recording mode.

The DVD controller 123 and the VCR controller 114, as will be described later in detail, are linked to each other at a time of the start point of the detected menu image signal, so that signals for controlling the DVDP 120 and the VCR 110 are generated. In the exemplary embodiment of the present invention, the VCR controller 114 and the DVD controller 123 may be separately provided and the VCR controller 114 may be used as a main controller of the combo system 100. However, the present invention is not limited to this embodiment. That is, the DVD controller 123 may be the main controller of the DVDP/VCR combo system 100 or a menu controller having both the functions of the VCR controller 114 and the DVD controller 123 may be used.

An output of the DVD encoder 124, outputs of the video and audio blocks 112 and 113, and the signals from the input block 140 are input as input signals to a selector 130. The VCR controller 114 and the DVD controller 123 control the selector 130 to select input signals. An output signal from the selector 130 is input to the OSD block 160 and the output block 150. The OSD block 160 adds the OSD function to the signal input from the selector 130 and generates video images. Accordingly, the video images generated by the OSD block 160 are added to video images output to a TV screen, such as a menu for controlling the operation of the DVDP 120 and the VCR 110 and various error messages.

The output block 150 receives the output signals from the DVD encoder 124, the selector 130, and the OSD block 160 and outputs DVD video signals, DVD audio signals, VCR video signals, and VCR audio signals. The peripheral devices such as the TV or audio devices are connected to the output block 150 and, thus, video and audio images are output from the peripheral devices.

The input block 140 is connected to the selector 130, and transmits an externally input signal to the selector 130. A signal output terminal of the external device, such as a camcorder is connected to the input block 140. Accordingly, the signal recorded on the external device can be transmitted to the combo system 100 through the input block 140, and also can be recorded on the magnetic tape using the VCR 110 or can be played through the TV or a monitor.

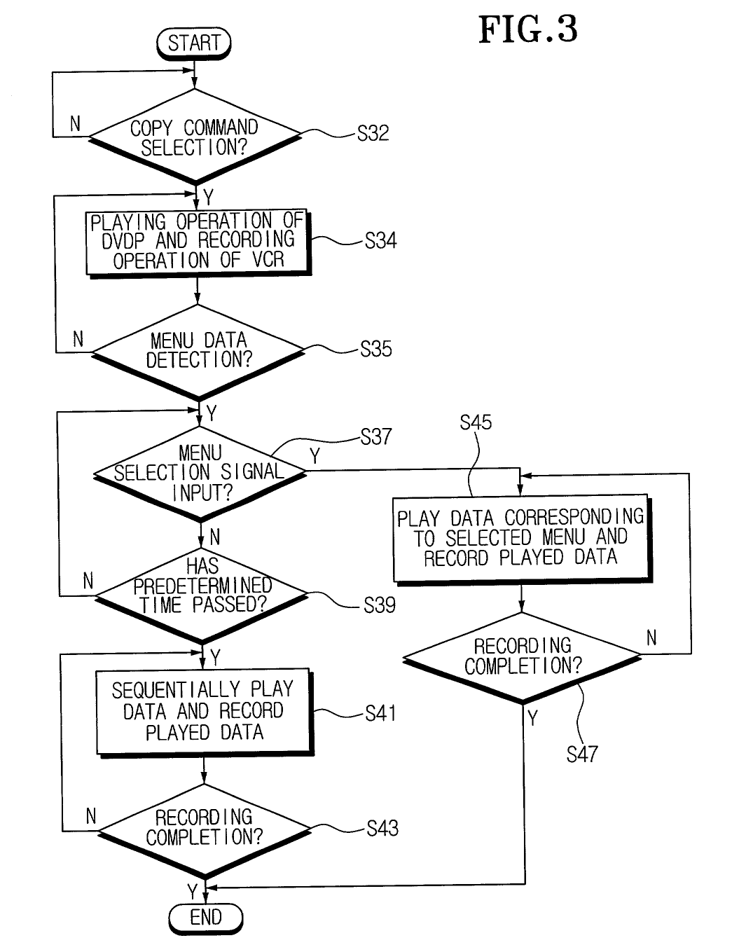

FIG. 3 is a flow chart illustrating an automatic copy method performed by the DVDP/VCR combo system 100 according to the present invention. In more detail, FIG. 3 is a flow chart illustrating an automatic copy method in which the user copies the data recorded on the DVD to the magnetic tape. The DVD data may be DVD audio data and/or DVD video data.

If a power source is applied to the combo system 100, the OSD block 160 outputs a data processing menu and displays the same on the TV screen. If the user selects a copy mode from the data processing menu displayed on the TV screen by manipulating the remote controller 180, a copy mode setting signal is transmitted to the VCR controller 114 through the remote controller sensor 118. At operation S32, the VCR controller 123 detects whether a copy command has been input.

Once the copy command is input, the VCR controller 114 outputs the copy mode setting signal to the DVD controller 123. At operation S34, the DVD controller 123 operates the DVD deck 121 in accordance with the copy mode setting signal to play the data recorded on the DVD and at the same time operates the menu data detector 128. Also, the VCR controller 114 drives the VCR deck 111 so as to record the signal played by the DVDP 120 on the magnetic tape.

In the above play mode, at operation S35, the menu data detector 128 detects the start point of the menu data among the data recorded on the DVD. Once the start point of the menu data is detected, at operation S37, the DVD controller 123 detects whether the menu selection signal has been input. If the menu selection signal is not detected, at operation S39, the DVD controller 123 checks whether a predetermined time has passed. For instance, the predetermined time is within the range of 5 seconds.

If the menu selection signal is not input after the predetermined time has passed, the DVD controller 123 operates the DVD deck 121 to sequence the data recorded on the DVD, and to output a recording operation signal to the VCR controller 114. Then, at operation S41, the VCR controller 114 operates the VCR deck 111 so as to record the data played by the DVD deck 121 on the magnetic tape. The DVD controller 123 drives the DVD deck 121 until all the data recorded on the DVD is played. At operation S43, the VCR controller 114 drives the VCR deck 111 until a play completion signal is input to the DVD controller 123, so that the recording operation is performed.

Furthermore, if the menu selection signal is input, then, at operation S45, data corresponding to the selected menu, among the data recorded on the DVD is played, and the played data is recorded on the magnetic tape. Because the play operation and the recording operation are equal to those of the operation S41, a detailed description thereof will be omitted. Also, the menu selection signal may be selected to successively copy one or more menus. Therefore, at operation S47, the play operation and the recording operation continue until it is determined that the recording operation is completed.

As described above, after detecting the menu image start point, the play command is automatically output to the DVD deck 121 based on the a recording structure of the DVD data. That is, the DVD data has a menu image signal in a front section of the data. The menu image signal is displayed as a still image or dynamic image on the TV monitor until the external selection signal is applied. Accordingly, in a conventional combo system in which an automatic play command is not input, if the user is absent after inputting a copy command, a problem arose in that the menu image signal recorded on the DVD is only copied on the magnetic tape. However, in the present invention, even if the user is absent after inputting a copy command, a play command is automatically output from the DVD controller 123 to the DVD deck 121, thereby preventing the menu image data from being repeatedly copied on the magnetic tape. Also, because the user can copy desired data, reliability of the device can be improved.

In an alternative embodiment, unlike the embodiment of FIG. 2 in which the play operation is controlled by the DVD controller 123 while the recording operation is controlled by the VCR controller 114, the play and recording operation may be controlled through one controller. Furthermore, as another embodiment of the present invention, in addition to the combo system, a protocol established between a player, such as the DVDP, and a recorder, such as the VCR, is set using a cable to perform communication, so that an automatic copy method between the player and the recorder is provided. That is, in a state where the protocol is set to mutually exchange the data and the control signals between the DVDP, to play the data recorded on the DVD, and the VCR, to record data on the magnetic tape, or to play the data recorded on the magnetic tape, a method for copying signals recorded on the DVD to the magnetic tape will be described below.

Generally, the DVDP includes the components of the DVDP 120 shown in FIG. 2. Specifically, the DVD controller 123 in the DVDP controls the entire operation of the DVDP and exchanging control signals and data with the VCR, the DVD deck 121 plays the data recorded on the DVD under the control of the DVD controller 123, and the menu data detector 128 detects the menu image data included in the played signal.

Also, a general VCR includes the components of the VCR 110 shown in FIG. 2,. Specifically, the VCR controller 114 in the VCR controls the entire operation of the VCR and exchanges control signals and data with the DVDP, and the VCR deck 111 plays the data recorded on the magnetic tape or records predetermined data on the magnetic tape under the control of the VCR controller 114. The VCR further includes the display block 116 to externally display the status of the VCR such as operational, control, and setting modes, the panel 117 to input various commands from the user, and the remote controller sensor 118 to input the commands from the user through a remote controller 180.

Therefore, if it is intended to copy the data recorded on the DVD on the magnetic tape using the individual DVDP and the individual VCR, the DVDP plays the data recorded on the DVD and detects the menu image data from the played data. Then, the DVDP performs the playing operation and the VCR performs the recording operation. Thus, the data recorded on the DVD can be copied on the magnetic tape in the same manner as by implementing the automatic copy method of the combo system shown in FIG. 3. As described above, the combination system and the automatic copy method thereof, according to the present invention have the following advantage: if the data recorded on the DVD having the menu image data is copied onto the magnetic tape, an unnecessary copying operation, such as successive copying of the same image can be avoided and reliability in the operation of the combo system can be improved.

While the present invention has been described and illustrated herein with reference to the preferred embodiments thereof, it will be apparent to those skilled in the art that various modifications and variations can be made therein without departing from the spirit and scope of the invention. Thus, it is intended that the present invention covers the modifications and variations of this invention that come within the scope of the appended claims and their equivalents.

What is claimed is:

1. A combo system having a play unit to play a signal recorded on a first recording medium and a recording unit to record the signal played by the play unit in a second recording medium, comprising:
a detector to detect whether a predetermined still image signal exists within the signal played by the play unit; and
a controller to control the play unit and the recording unit to perform a playing operation and a recording operation, respectively, when the still image signal is detected by the detector.

2. The combo system according to claim 1, wherein the recording unit comprises a VCR to record the signal on a magnetic tape as the second recording medium.

3. The combo system according to claim 2, wherein the play unit comprises a DVD player to play a signal recorded on a DVD as the first recording medium.

4. The combo system according to claim 1, wherein the still image signal is a menu image signal that provides a predetermined selection menu to a user through an OSD function

5. The combo system according to claim 4, wherein, once the still image signal is detected and after a predetermined time has elapsed, the controller controls the play unit to perform the playing operation.

6. The combo system according to claim 5, wherein, once the menu selection signal is input by the user within a predetermined time after the still image signal is detected, the controller controls the play unit to play data corresponding to a selected menu.

7. The combo system according to claim 5, wherein the controller controls the play unit to sequentially play the data recorded on the first recording medium from first recorded data to last recorded data.

8. An automatic copy method of a combo system provided with a play unit and a recording unit, comprising:
playing a signal recorded on a first recording medium using the play unit;
recording the signal onto a second recording medium using the recording unit;
detecting whether a predetermined still image signal exists within the signal played by the play unit; and
performing a playing operation of the play unit and a recording operation of the recording unit when the still image signal is detected.

9. The automatic copy method according to claim 8, wherein the recording unit comprises a VCR to record the signal on a magnetic tape.

10. The automatic copy method according to claim 9, wherein the play unit comprises a DVD player to play a signal recorded on a DVD.

11. The automatic copy method according to claim 8, wherein the still image signal is a menu image signal that provides a predetermined selection menu to a user through an OSD function.

12. The automatic copy method according to claim 11, wherein once the still image signal is detected and after a predetermined time has elapsed, the playing operation is performed.

13. The automatic copy method according to claim 12, wherein after the still image signal is detected and the user inputs a menu selection signal within a predetermined time, data corresponding to the selected menu is played.

14. The automatic copy method according to claim 12, wherein the playing operation is performed to sequentially play the data recorded on the first recording medium from first recorded data to last recorded data.

15. An automatic copy method between a play unit and a recording unit, comprising:
playing a signal recorded on a first recording medium using the play unit;
recording the signal onto a second recording medium using the recording unit;
detecting whether a predetermined still image signal exists within the signal played by the play unit; and
performing a playing operation of the play unit and a recording operation of the recording unit when the still image signal is detected.

16. The automatic copy method according to claim 15, wherein the recording unit comprises a VCR to record the signal on a magnetic tape.

17. The automatic copy method according to claim 16, wherein the play unit comprises a DVD player to play a signal recorded on a DVD.

18. The automatic copy method according to claim 15, wherein the still image signal is a menu image signal that provides a predetermined selection menu to a user through an OSD function.

19. The automatic copy method according to claim 18, wherein once the still image signal is detected and after a predetermined time has elapsed, the playing operation is performed.

20. The automatic copy method according to claim 19, wherein after the still image signal is detected and the user inputs a menu selection signal within a predetermined time, data corresponding to the selected menu is played.

21. The automatic copy method according to claim 19, wherein the playing operation is performed to sequentially play the data recorded on the first recording medium from first recorded data to last recorded data.

22. A combo system, comprising:
a play unit playing video and/or audio signals recorded on a first recording medium;
a recording unit recording the video and/or audio signals onto a second recording medium;
a controller detecting a still image signal from the video and/or audio signals played by the play unit; and
an OSD block adding an OSD function to the video signals and generating video images, wherein the video images generated by the OSD block are added to the video signals from the recording unit.

23. The combo system as recited in claim 22, wherein the recording unit comprises:
video and audio blocks transmitting and receiving video and audio signals to be recorded or played to and from the recording unit,
a display block displaying a status of the recording unit, and
a recording unit controller controlling an operation of the recording unit.

24. The combo system as recited in claim 23, wherein the play unit comprises:
a deck reading data recorded on the first recording medium to perform a play mode,
a servo receiving the data read by the deck and outputting the video and/or audio signals, and
a play unit controller controlling an operation of the play unit.

25. The combo system as recited in claim 22, wherein the signal comprises audio data and/or video data.

26. An automatic copy method in which a user copies data recorded on a first recording medium on a second recording medium, the method comprising:
selecting a copy command signal from a data processing menu;
playing data recorded on the first recording medium in response to the copy command signal;
recording the data onto the second recording medium;
detecting a start point of a menu data among the data recorded on the first recording medium;
detecting a menu selection signal to select data from the menu data;
playing the selected data from the menu data;
recording the selected data on the second recording medium; and
detecting a play completion signal.

27. The automatic copy method according to claim 26, wherein when the menu selection signal is not detected, the method further comprises:
checking whether a predetermined time has expired; and
sequentially playing and recording the data recorded on the first recording medium onto the second recording medium.

28. The automatic copy method according to claim 26, further comprising:
selecting the menu selection signal to successively copy one or more menus.

29. A combo system having a play unit to play a signal recorded on a first recording medium and a recording unit to record the signal played by the play unit in a second recording medium, comprising:
a detector detecting a still image signal from video and/or audio signals; and
a controller preventing the still video signal from being continuously recorded.

30. A combo system having a play unit and a recording unit, comprising:
a detector detecting a still image or a menu image and generating a detection signal indicative thereof; and
a controller controlling the play unit to perform a play operation to reproduce data different from the detected still image or menu image in response to the detection signal.

31. The combo system according to claim 30, wherein the recording medium stores the detected still image and the menu image, and the play unit automatically performs the play operation to reproduce the data different from the stored still image and the menu image corresponding to the detection signal.

32. The combo system according to claim 31, wherein the recording unit automatically records the data when the data is reproduced from the play unit.

33. An apparatus in a DVD play unit having a recording medium, comprising:
a detector detecting a still image or a menu image and generating a detection signal indicative thereof; and
a controller controlling the DVD play unit to perform a play operation in response to the detection signal.

34. The apparatus according to claim 33, wherein the controller controls the DVD play unit to automatically reproduce data a predetermined period after the detected still image or menu image is reproduced from the recording medium.

35. An apparatus in a DVD play unit having a recording medium, comprising:
a detector detecting a still image or a menu image recorded on the recording medium to generate a detection signal; and
a controller controlling the DVD play unit to perform a play operation to reproduce data different from the detected still image or menu image from the recording medium in response to the detection signal.

36. A method of a combo system having a play unit and a recording unit, comprising:
detecting a still image or a menu image and generating a detection signal indicative thereof; and
controlling the play unit to perform a play operation to reproduce data different from the detected still image or menu image in response to the detection signal.

37. The method according to claim 36, further comprising:
storing the detected still image and menu image; and
automatically performing the play operation to reproduce the data different from the stored still image and menu image corresponding to the detection signal.

38. The method according to claim 37, further comprising:
automatically recording the data when the data is reproduced.

39. A method of a DVD play unit having a recording medium, comprising:
detecting a still image or a menu image and generating a detection signal indicative thereof; and
controlling the DVD play unit to perform a play operation in response to the detection signal.

40. The method according to claim 39, further comprising:
controlling the DVD play unit to automatically reproduce data a predetermined period after the detected still image or menu image is reproduced.

41. A method of a DVD play unit having a recording medium, comprising:
detecting a still image or a menu image recorded on the recording medium to generate a detection signal; and
controlling the DVD play unit to perform a play operation to reproduce data different from the detected still image or menu image from the recording medium in response to the detection signal.
